(19) United States
(12) Patent Application Publication
(10) Pub. No.: US 2025/0165705 A1
(43) Pub. Date: May 22, 2025

(54) TABLE CREATION METHOD, ELECTRONIC DEVICE, AND STORAGE MEDIUM

(71) Applicant: Beijing Zitiao Network Technology Co., Ltd., Beijing (CN)

(72) Inventors: Andi GUAN, Beijing (CN); Haochun LIAO, Beijing (CN); Zhang YUAN, Beijing (CN); Qinghong CHEN, Beijing (CN)

(21) Appl. No.: 18/953,460

(22) Filed: Nov. 20, 2024

(30) Foreign Application Priority Data
Nov. 21, 2023 (CN) 202311562595.5

(51) Int. Cl. G06F 40/177; G06F 3/0484; G06F 40/186

(52) U.S. Cl. CPC G06F 40/177; G06F 3/0484; G06F 40/186

(57) ABSTRACT

Embodiments of the present disclosure provide a table creation method, an electronic device, and a storage medium. A first user input instruction is received through an interaction component in a table interface, where the first user input instruction includes table creation requirement information; a language model is invoked based on the first user input instruction, to create a target table that satisfies the table creation requirement information; and the target table is presented in the table interface. In the embodiments of the present disclosure, a user only needs to input table creation requirement information, so that a table that satisfies a user requirement can be automatically created by means of a language model, thereby implementing efficient and flexible table creation, reducing labor costs, and providing convenience for the user.

### CROSS-REFERENCE TO RELATED APPLICATION

The present application claims priority of the Chinese Patent Application No. 202311562595.5, filed on Nov. 21, 2023, the disclosure of which is incorporated herein by reference in its entirety as part of the present application.

### TECHNICAL FIELD

Embodiments of the present disclosure relate to the field of computer and network communication technologies, and in particular, to a table creation method and device, and a storage medium.

### BACKGROUND

With rapid development of science and technology and increasing prominence of data value, tables have become a commonly used form of data presentation and data recording in various industries.

In the prior art, when a table is created, it is usually designed by a creator according to their own requirements, including the design of a table subject, a field name, a format, etc. However, the table design process is inefficient, and requires a large amount of time and energy especially for some scenarios with extensive information, resulting in the waste of labor costs.

### SUMMARY

Embodiments of the present disclosure provide a table creation method and device, and a storage medium, to implement efficient and flexible table creation, reduce labor costs, and provide convenience for a user.

An embodiment of the present disclosure provides a table creation method. The method includes:
receiving a first user input instruction through an interaction component in a table interface, where the first user input instruction includes table creation requirement information;
invoking a language model based on the first user input instruction, to create a target table that satisfies the table creation requirement information; and
presenting the target table in the table interface.

An embodiment of the present disclosure provides a table creation device. The device includes: an input unit, a processing unit, and a display unit,
the input unit is configured to receive a first user input instruction through an interaction component in a table interface, where the first user input instruction includes table creation requirement information;
the processing unit is configured to invoke a language model based on the first user input instruction, to create a target table that satisfies the table creation requirement information; and
the display unit is configured to present the target table in the table interface.

An embodiment of the present disclosure provides an electronic device. The electronic device includes: at least one processor and a memory,
where the memory stores computer-executable instructions; and
the at least one processor executes the computer-executable instructions stored in the memory, to cause the at least one processor to perform the table creation method.

An embodiment of the present disclosure provides a computer-readable storage medium. The computer-readable storage medium stores computer-executable instructions. When executing the computer-executable instructions, a processor implements the table creation method.

An embodiment of the present disclosure provides a computer program product, including computer-executable instructions. When executing the computer-executable instructions, a processor implements the table creation method.

### BRIEF DESCRIPTION OF DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show some embodiments of the present disclosure, and persons of ordinary skill in the art may still derive other accompanying drawings from these accompanying drawings without creative efforts.

FIG. 1 is an example diagram of table creation in the prior art;

FIG. 2 is a schematic flowchart of a table creation method according to an embodiment of the present disclosure;

FIG. 3 is a schematic diagram of a table interface according to an embodiment of the present disclosure;

FIG. 4 is a schematic diagram of a table interface according to another embodiment of the present disclosure;

FIG. 5 is a schematic diagram of a table interface according to another embodiment of the present disclosure;

FIG. 6 is a schematic diagram of a table interface according to another embodiment of the present disclosure;

FIG. 7 is a schematic diagram of a table interface according to another embodiment of the present disclosure;

FIG. 8 is a schematic diagram of a table interface according to another embodiment of the present disclosure;

FIG. 9 is a block diagram of a structure of a table creation device according to an embodiment of the present disclosure; and

FIG. 10 is a schematic diagram of a hardware structure of an electronic device according to an embodiment of the present disclosure.

### DETAILED DESCRIPTION

In order to make the objects, technical solutions and advantages of embodiments of the present disclosure clearer, the technical solutions in the embodiments of the present disclosure will be described clearly and completely below with reference to the accompanying drawings in the embodiments of the present disclosure. Obviously, the embodiments described are some of, rather than all of, the embodiments of the present disclosure. All the other embodiments obtained by those of ordinary skill in the art based on the embodiments of the present disclosure without any creative effort shall fall within the scope of protection of the present disclosure.

In the prior art, when a table is created, it is usually designed by a creator according to their own requirements, including the design of a table subject, a field name, a format, etc. However, the table design process is inefficient, and requires a large amount of time and energy especially for some scenarios with extensive information, resulting in the waste of labor costs.

To resolve the above technical problem, the present disclosure expects to implement automatic table creation. A user only needs to input a table creation requirement to automatically create a table that satisfies the table creation requirement. To implement the above objective, considering that the table creation requirement that is input by the user is usually based on natural language, and a language model has a natural language understanding capability and can implement a specific processing task after being trained, especially a large language model (LLM) has a very strong natural language understanding capability and shows a level close to or even beyond that of a human being in a plurality of natural language tasks. The table that satisfies a user requirement is automatically created by means of the language model in the present disclosure. In this way, efficient and flexible table creation is implemented without a manual table design, labor costs are reduced, and convenience is provided for the user.

A table creation method provided in the present disclosure may be performed by an electronic device such as a terminal device or a server. A language model is locally deployed on the electronic device such as the terminal device or the server. A first user input instruction is received through an interaction component in a table interface, where the first user input instruction includes table creation requirement information; the language model is invoked based on the first user input instruction, to create a target table that satisfies the table creation requirement information; and the target table is presented in the table interface.

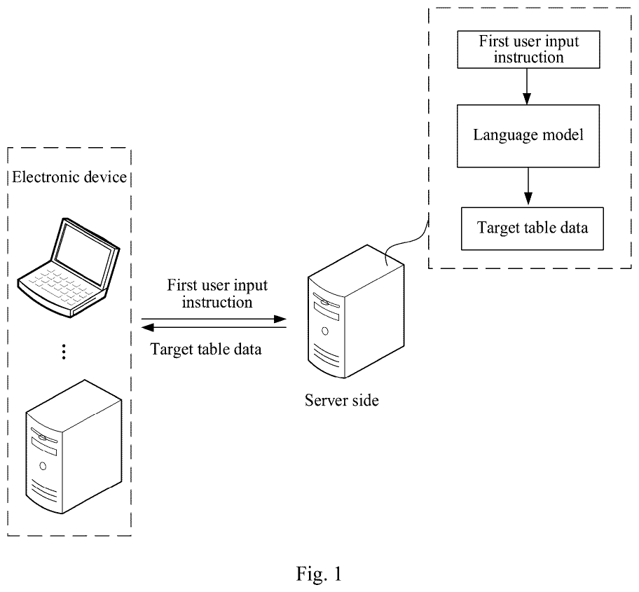

Optionally, the language model may not be deployed on the electronic device such as the terminal device or the server, and the language model is deployed on a server side. As shown in FIG. 1, the electronic device such as the terminal device or the server may receive a first user input instruction through an interaction component in a table interface, where the first user input instruction includes table creation requirement information. Then, the first user input instruction is sent to the server side. The server side invokes the language model based on the first user input instruction, to obtain target table data that satisfies the table creation requirement information, and sends the target table data to the electronic device. The electronic device creates a target table based on the target table data, and displays the target table in the table interface.

It should be noted that user information and data involved in the present application are information and data for which an authorization is obtained from the user or a full authorization is obtained from each party, the collection, use, and processing of relevant data need to comply with relevant laws, regulations, and standards of relevant countries and regions, and the corresponding operation entries are provided for the user to choose to authorize or deny.

The table creation method in the present disclosure is described in detail below with reference to specific embodiments.

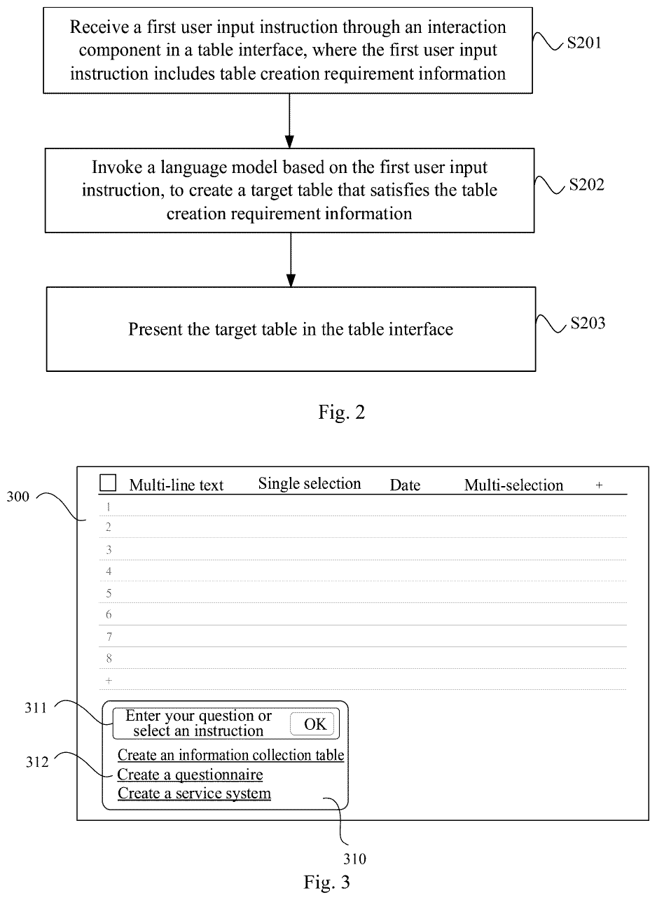

With reference to FIG. 2, FIG. 2 is a schematic flowchart of a table creation method according to an embodiment of the present disclosure. The method in this embodiment can be applied to an electronic device such as a terminal device or a server. The table creation method includes the following steps.

S201: Receive a first user input instruction through an interaction component in a table interface, where the first user input instruction includes table creation requirement information.

In this embodiment, the interaction component may be configured in the table interface. The interaction component is an interface of a function for invoking a language model to automatically create a table. A user may input, into the interaction component, an input instruction that includes various types of requirement information. When the user needs to create a table, the user may input the first user input instruction through the interaction component. The first user input instruction includes the table creation requirement information. The table creation requirement information may include but is not limited to subject information, format information, a required field, required data, and the like of the table. For example, the table creation requirement information may be creating a table whose subject is “Recruitment management system”.

In some embodiments of the present disclosure, the table may be a database table, an online table, a spreadsheet, or the like.

Optionally, an input box control may be provided in the interaction component. As shown in FIG. 3, in a table interface 300, an input box control 311 may be provided in an interaction component 310, and the user may input instruction content that is based on natural language into the input box control 311, for example, the user may input “Help me build a recruitment management system” in the input box control 311, and click to confirm. The electronic device may receive the instruction content that is based on the natural language and that is input into the input box control 311, and determine the instruction content to be the above first user input instruction. A manner of inputting the instruction content into the input box control includes but is not limited to keyboard input, voice input, handwriting input, or the like.

Optionally, a preset shortcut instruction control may also be provided in the interaction component. For example, as shown in FIG. 3, the preset shortcut instruction control 312 is provided in the interaction component 300, and includes the shortcut instruction control, “Create a service system”, the shortcut instruction control, “Create a questionnaire”, and the like. The user may directly select and trigger a required preset shortcut instruction control. In response to a trigger operation by the user on the preset shortcut instruction control, the electronic device directly uses a preset shortcut instruction corresponding to the preset shortcut instruction control as the first user input instruction. The trigger operation includes but is not limited to triggering (for example, clicking) via an input device such as a mouse, voice triggering, gesture triggering, or the like.

Optionally, some preset shortcut instruction controls further require the user to provide some parameters or information. When the user triggers these preset shortcut instruction controls, the electronic device displays a preset prompt corpus in the input box control in the interaction component in response to a trigger operation on these preset shortcut instruction controls. The preset prompt corpus is used to indicate, to the user, the content that needs to be input. The user may continue to input the instruction content that is based on the natural language into the input box control. After the user clicks to confirm, the electronic device may determine the preset prompt corpus and the instruction content that is input by the user to be the first user input instruction. For example, the shortcut instruction control, “Create a data table”, is provided in the interaction component. After the user triggers the shortcut instruction control “Create a data table”, the preset prompt corpus “Create a data table, the subject is:” may be displayed in the input box control of the interaction component. The user may continue to input a subject “Subject A” of the required data table in an input box. After the user clicks to confirm, all content in the input box control, including “Create a data table, the subject is: Subject A” that is the preset prompt corpus and the instruction content that is input by the user, may be determined to be the first user input instruction.

Optionally, in the process in which the user inputs the instruction content that is based on natural language into the input box control, the electronic device may search for a matched preset shortcut instruction control in real time based on the current instruction content in the input box control, and display the matched preset shortcut instruction control in the interaction component for the user to select. The user may stop continuing to input in the input box control, but directly select and trigger a required preset shortcut instruction control. In response to a trigger operation by the user on the preset shortcut instruction control, the electronic device directly uses a preset shortcut instruction corresponding to the preset shortcut instruction control as the first user input instruction.

It should be noted that the interaction component may provide one or more of the above input manners without a conflict, to facilitate user input. In addition, the above input manner for the interaction component is not limited to obtaining the first user input instruction when a table is created, but is also applicable to another scenario. Any user input instruction may be collected, for example, a second user input instruction and a third user input instruction in the following embodiment.

S202: Invoke a language model based on the first user input instruction, to create a target table that satisfies the table creation requirement information.

In this embodiment, after the first user input instruction is obtained through the interaction component, the language model may be invoked, and the target table that satisfies the table creation requirement information in the first user input instruction is automatically created by the language model.

The language model may be a large language model (LLM). The large language model is a new language model constructed based on deep learning in the natural language field, is characterized by a very large parameter scale (which usually includes at least one billion parameters), and is trained using massive natural language corpora. Benefit from these characteristics, the large language model has a very strong natural language understanding capability, and shows a level close to or even beyond that of a human being in a plurality of natural language tasks. In this embodiment, the large language model can be trained to automatically create the table based on the table creation requirement information.

Further, in S202, the invoking a language model based on the first user input instruction, to create a target table that satisfies the table creation requirement information may specifically include the following steps.

S2021: Generate model input data using a preset template based on the first user input instruction.

S2022: Process the model input data based on the language model, to obtain target table data that satisfies the table creation requirement information.

S2023: Parse the target table data, and create the target table in the table interface based on a parsing result.

In this embodiment, the first user input instruction may be the natural language or a preset shortcut instruction. To facilitate understanding of the language model, the first user input instruction may be processed using the preset template, to generate the model input data. For example, for the large language model, the model input data may be generated using a prompt template based on the first user input instruction, where a prompt is a structured text used as an input to the large language model, and the prompt template specifies a fixed format of the prompt, and includes some variable parts with replaceable content. Extraction may be performed on the first user input instruction and the variable part in the prompt template may be replaced, to finally obtain the model input data. Certainly, in this embodiment, another feasible language model may alternatively be used. This is not limited herein.

Further, the model input data is input into the language model, semantic understanding is performed on the model input data using a strong natural language understanding capability of the language model, and the target table data that satisfies the table creation requirement information is obtained. The target table data includes one or more of the following: the number of tables included in the target table, a subject of each table, a field name in the table, an option of at least one field, example data in the table, and real data in the table.

For example, when the table creation requirement information is creating a table whose subject is “Recruitment management system”, the language model may determine to generate a plurality of tables around the subject of “Recruitment management system”, where each table may have its own subject. For example, a first table has a subject of “Job list”, a second table has a subject of “Candidate resume”, and a third table has a subject of “Interview record table”. The language model may further determine a field name in each table. For example, the first table “Job list” may include field names such as job ID, job title, job type, salary range, and job description. The second table “Candidate resume” may include field names such as resume ID, name, and desired job. The third table “Interview record table” may include field names such as record ID, candidate resume ID, interview time, interviewer, and interview result. In addition, for some fields, the language model may further provide an option. For example, options for the desired job field include a sales position, a research and development position, a management position, and the like, and options for the interview result field include pass, fail, pending, and the like. In addition, the language model may further provide several pieces of example data (which is several example records, where one record is one row of data in the table) for each table. For example, several pieces of virtual data are provided. Certainly, for some table creation requirements, the language model may also provide some real data. For example, when the table creation requirement is creating a comparison table between provinces and provincial capital cities, the language model may provide real data of the provinces and the provincial capital cities. For another example, when the table creation requirement is recommending five economics and management books, the language model may provide real data of five economics and management books based on a corpus.

The language model may output the target table data in a predetermined format. Further, the target table data may be parsed, and the target table may be created in the table interface based on the parsing result. In a specific creation process, a streaming process may be used. When there are a plurality of tables, the tables may be created one by one, that is, after the creation of a table is completed, a next table is created. During the creation of any table, fields are generated one by one in the table, and then example data or real data is written in the table row by row with reference to the fields, to obtain the target table.

S203: Present the target table in the table interface.

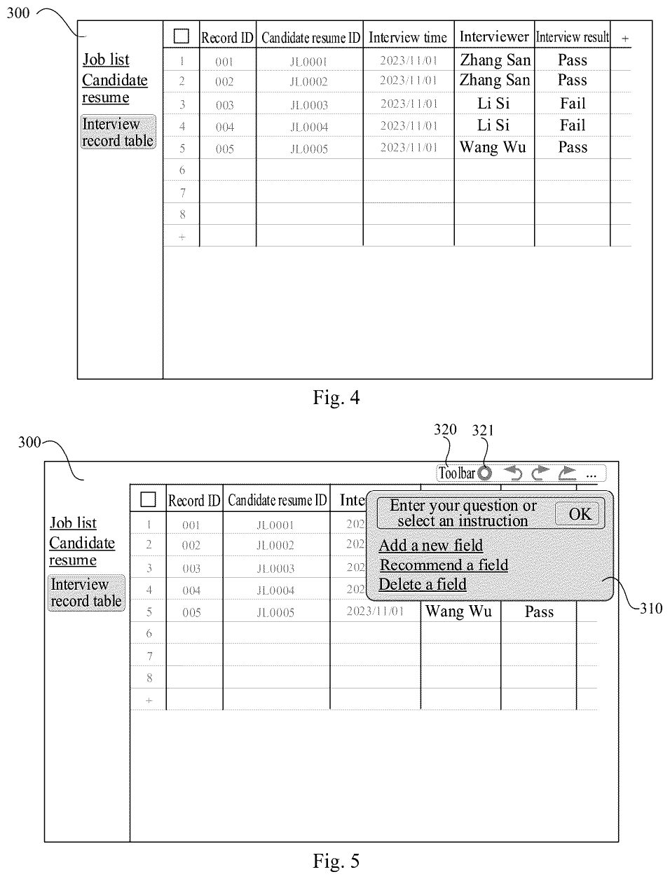

In this embodiment, the final target table may be directly displayed in the table interface. For example, as shown in FIG. 4, when there are a plurality of tables, a name (or a subject) of each table may be displayed in a list, and one of the tables is displayed in the table interface. The user may alternatively select the table that needs to be displayed from the list.

Certainly, the above streaming process may also be presented in the table interface, and the final target table is presented after the streaming process ends.

According to the table creation method provided in this embodiment, the first user input instruction is received through the interaction component in the table interface, where the first user input instruction includes the table creation requirement information; the language model is invoked based on the first user input instruction, to create the target table that satisfies the table creation requirement information; and the target table is presented in the table interface. In this embodiment, the user only needs to input the table creation requirement information, so that a table that satisfies a user requirement can be automatically created by means of the language model, thereby implementing efficient and flexible table creation, reducing labor costs, and providing convenience for the user.

Based on any one of the above embodiments, after the target table is presented in the table interface, the method may further include:
receiving a second user input instruction through the interaction component, where the second user input instruction includes field modification requirement information for the target table, and the field modification requirement information includes requirement information for modifying an existing field, requirement information for deleting an existing field, or requirement information for adding a new field; and
invoking the language model based on the second user input instruction, to perform field modification on the target table based on the field modification requirement information.

In this embodiment, after the target table is presented in the table interface, when the user needs to modify a field in the target table, for example, modify an existing field, delete an existing field, or add a new field, the second user input instruction may be input into the interaction component, where the second user input instruction includes any of the above field modification requirement information.

The manner of receiving the second user input instruction through the interaction component is similar to the manner of receiving the first user input instruction in the above embodiment, which may be that the user directly inputs the instruction content that is based on natural language into the input box control of the interaction component as the second user input instruction; may be setting a preset shortcut instruction control related to field modification in the interaction component for the user to select, for example, a preset shortcut instruction control for recommending a new field; may also be that after a preset shortcut instruction control related to field modification is triggered, a preset prompt corpus is displayed in the input box control, the user may continue to input instruction content into the input box control based on the preset prompt corpus, and the preset prompt corpus and the instruction content that is input by the user are used as the second user input instruction. A specific process is not described herein again. As shown in FIG. 5, the interaction component 310 may be expanded by triggering a thumbnail identifier 321 of the interaction component in a toolbar 320, or the display of the interaction component may be triggered in another manner.

Further, based on the second user input instruction, the language model is invoked to perform field modification on the target table, to satisfy the field modification requirement information. Specifically, similar to the above embodiment, the model input data is generated using a preset template based on the second user input instruction, the model input data is processed based on the language model, and the target table data is updated based on the field modification requirement information. For example, an existing field is modified, an existing field is deleted, or a new field is added for the target table. Correspondingly, example data or real data corresponding to the existing field is modified, example data or real data corresponding to the existing field is deleted, or example data or real data corresponding to the new field is added. In addition, the target table in the table interface is updated based on the updated target table data.

Based on any one of the above embodiments, after the target table is presented in the table interface, the method further includes:
receiving a third user input instruction through the interaction component, where the third user input instruction includes data addition requirement information for the target table, and the data addition requirement information includes data information to be added that is based on natural language; and
invoking the language model based on the third user input instruction, to add the data information to be added to a row of the target table according to a field.

In this embodiment, when the user uses the target table, when a row of data needs to be added, the interaction component may also be used for implementation. The user may input the third user input instruction through the interaction component, where data addition requirement information for the target table is included in the third user input instruction and is used to indicate a data addition requirement for the target table and specific data to be added. The data addition requirement information includes the data information to be added that is based on natural language.

The manner of receiving the third user input instruction through the interaction component is similar to the manner of receiving the first user input instruction in the above embodiment, which may be that the user directly inputs the data information to be added that is based on natural language into the input box control of the interaction component as the third user input instruction; may be setting a preset shortcut instruction control related to data addition in the interaction component for the user to select; may also be that after the user triggers the preset shortcut instruction control related to data addition, a preset prompt corpus, for example, “Enter a row of records and disassemble into corresponding fields”, is displayed in the input box control, the user may continue to input the data information to be added that is based on natural language into the input box control based on the preset prompt corpus, and the preset prompt corpus and the data information to be added that is based on natural language and input by the user are used to be the third user input instruction. A specific process is not described herein again.

Further, the language model may be invoked based on the third user input instruction, to recognize and split the data information to be added according to a field in the target table, and the obtained data corresponding to each field is added to a cell corresponding to each field in a row of the target table.

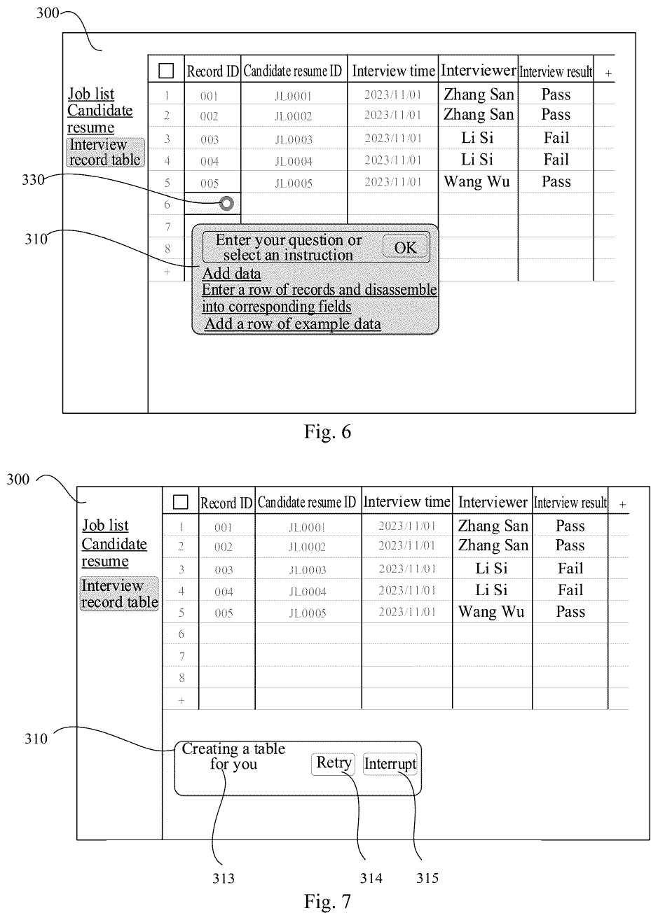

Optionally, when the user needs to add a row of data to the target table, the user may perform a trigger operation on any cell in any row of the target table. For example, the user may click an index-column cell in a blank row of the target table, and the electronic device may display a thumbnail identifier of the interaction component in the cell in response to the trigger operation performed by the user on the cell. For example, as shown in FIG. 6, a thumbnail identifier 330 of the interaction component is displayed on a right side or a left side of the cell. After the user triggers the thumbnail identifier 330, the electronic device displays the interaction component 310 in response to the trigger operation on the thumbnail identifier 330. The user may further input the third user input instruction through the interaction component 310, to finally add a row of data to the row by means of the language model.

Optionally, in the case that the user does not specify a specific row for adding the data to be added, the data to be added may be added to the last row of the target table by default.

Based on any one of the above embodiments, during the process of invoking a language model based on the first user input instruction, to create a target table that satisfies the table creation requirement information in S202, the method further includes:
displaying creation status prompt information and a preset operation instruction control for the current creation process in the interaction component, where the preset operation instruction control for the creation process includes a retry control and/or an interruption control.

As shown in FIG. 7, the creation status prompt information 313 is displayed in the interaction component 310, and is used to indicate, to the user, that the target table is being created. For example, the creation status prompt information may be “Creating a table for you”. In addition, a preset operation instruction control displayed in the interaction component for a current creation process is used to control the current creation process, including but not limited to retry and/or interruption. In other words, the preset operation instruction control for the creation process may include but is not limited to a retry control and/or an interruption control. For example, the interaction component 310 in FIG. 7 includes a retry control 314 and an interruption control 315.

When the user triggers the retry control, in response to a trigger operation on the retry control, the electronic device stops the current creation process, revokes the generated target table, and re-invokes the language model based on the first user input instruction, to create the target table that satisfies the table creation requirement information. Because the language model is indeterminate, in the case that the first user input instruction is unchanged, the language model may create a different target table during retry.

When the user triggers the interruption control, in response to a trigger operation on the interruption control, the electronic device stops the current creation process, may retain the generated target table or certainly may revoke the generated target table, and may close or hide the interaction component or certainly may not close or hide the interaction component.

Based on any one of the above embodiments, after the target table is presented in the table interface in S203, the method further includes:
displaying a preset operation instruction control for the target table in the interaction component, where the preset operation instruction control for the target table includes one or more of an acceptance control, a retry control, and a discard control.

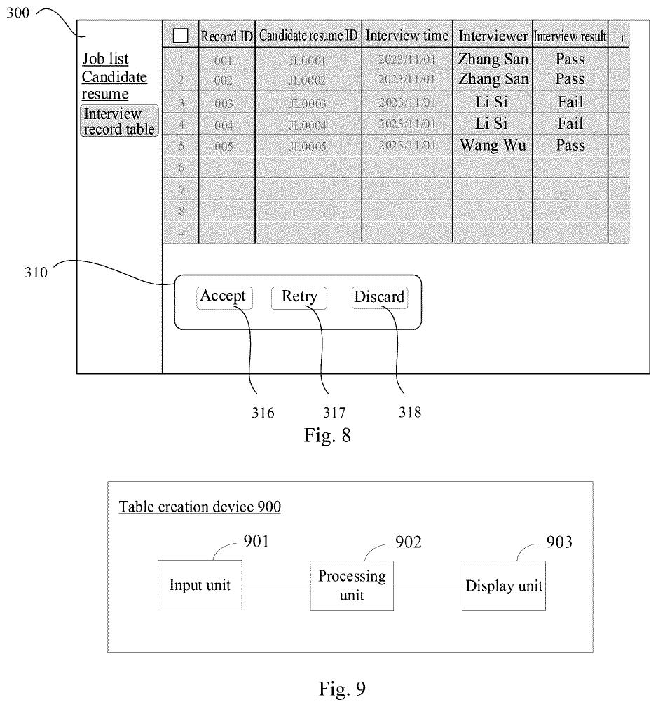

In this embodiment, the preset operation instruction control for the target table is used by the user to perform an operation on the target table, where the operation includes but is not limited to accepting the target table, discarding the target table, or regenerating the target table. In other words, the preset operation instruction control for the target table includes but is not limited to one or more of an acceptance control, a retry control, and a discard control. As shown in FIG. 8, the interaction component 310 includes an acceptance control 316, a retry control 317, and a discard control 318.

When the user is relatively satisfied with the target table, the acceptance control may be triggered. In response to a trigger operation on the acceptance control, the electronic device completes the creation of the target table, and exits the interaction component. Optionally, before the target table is accepted, the target table may be in a highlighted state, that is, the target table is presented in the table interface in the highlighted state in S203 after the target table is created. Before the user triggers the acceptance control, the target table remains in the highlighted state until the user triggers the acceptance control, and then the target table returns to a normal state, that is, the target table is changed from the highlighted state to a non-highlighted state, indicating that creation of the target table is completed.

When the user is not satisfied with the target table, the user may trigger the retry control. In response to a trigger operation on the retry control, the electronic device revokes the target table, and re-invokes the language model based on the first user input instruction, to create a target table that satisfies the table creation requirement information.

When the user is not satisfied with the target table, the user may alternatively trigger the discard control. In response to a trigger operation on the discard control, the electronic device revokes the target table, and exits (or hides) the interaction component, or certainly may not close or hide the interaction component.

Based on any one of the above embodiments, in the process of creating the target table or after the target table is created, when the user triggers another area outside the interaction component, the electronic device may display first prompt information in response to a trigger operation on the another area outside the interaction component, where the first prompt information includes prompt information for accepting or discarding the generated target table or prompt information for interrupting the current creation process. When the user triggers another area outside the interaction component after the target table is created, the first prompt information is displayed to query the user whether to accept or discard the generated target table. When the user triggers another area outside the interaction component in the process of creating the target table, the first prompt information is displayed to query the user whether to interrupt the current creation process. Optionally, the first prompt information may be displayed in a form such as a pop-up window, and the pop-up window may include a confirm control or a reject control for the first prompt information.

In addition, another exit manner may be further provided, for example, triggering a specified key (for example, an Esc key) on a keyboard, or for another example, triggering a specified key (for example, a Delete key) on a keyboard when the input box control is blank. Examples are not provided one by one herein.

Based on any one of the above embodiments, considering that a capability of the language model is limited, it may not be possible to process all user input instructions and obtain a proper result. Therefore, for any user input instruction that is based on natural language and input into the input box control in the interaction component, which includes but is not limited to the above first user input instruction, second user input instruction, and third user input instruction, when it is determined that the language model fails to perform processing (failing to perform processing in a current table creation scenario), second prompt information is displayed in the interaction component, where the second prompt information is used to indicate that the user input instruction fails to be processed or is used to prompt the user to input another instruction. For example, in a table creation scenario, when a user input instruction is querying current weather, and it is determined that the language model fails to perform processing in the current table creation scenario, the second prompt information may be displayed in the interaction component, to notify the user that the user input instruction fails to be processed or prompt the user to input another instruction. For example, the user is prompted to input another instruction in a question and answer manner. Certainly, the language model may alternatively display current weather in the interaction component. The above solution is applicable to the case where the language model fails to perform processing or the case where a question and answer intention escapes.

In any one of the above embodiments, different entries of the interaction component may be set in the table interface for different cases.

For example, in an optional case, the thumbnail identifier of the interaction component may be displayed at a preset position in the table interface, for example, the thumbnail identifier of the interaction component is displayed in a toolbar in the table interface. When the user triggers the thumbnail identifier of the interaction component that is displayed at the preset position, the electronic device displays the interaction component in response to the trigger operation on the thumbnail identifier. The interaction component may be displayed at a preset fixed position, or may be displayed within a preset range near the thumbnail identifier, or the interaction component may float above the table interface. In addition, the user may drag or scale the interaction component.

For another example, in another optional case, when a table is created, the interaction component or the thumbnail identifier of the interaction component is displayed at the bottom of a blank table in the table interface.

For another example, in another optional case, when the user needs to add a row of data to be added to the target table, the thumbnail identifier of the interaction component may be displayed in the cell that is triggered by the user. Alternatively, when the user triggers an index-column cell in a blank row, the thumbnail identifier of the interaction component is displayed in the index-column cell in the blank row or another cell in the blank row. When the user triggers the thumbnail identifier of the interaction component that is displayed at a preset position, the electronic device displays the interaction component in response to a trigger operation on the thumbnail identifier. The interaction component may be displayed at a preset fixed position, or may be displayed within a preset range near the thumbnail identifier, or the interaction component may float above the table interface. In addition, the user may drag or scale the interaction component.

For another example, in another optional case, in the process of creating the target table, the interaction component may be displayed below the target table. Optionally, the interaction component may follow a row of example data or real data that is last generated in the target table and is displayed below the row of example data or real data that is last generated (following below a field name row when a field is generated). Optionally, a Y-axis coordinate of a position of the interaction component in the table interface continuously changes with the row of example data or real data that is last generated, but an X-axis coordinate does not change. The Y-axis coordinate does not change when reaching the bottom of the table interface.

It should be noted that different cases in the table interface are not limited to the above examples. Another optional case is not described in this embodiment.

In addition, in any one of the above embodiments, for different cases, it is provided that different preset shortcut instruction controls are displayed in the interaction component. For example, before a table is created (a blank table is displayed in the table interface), a preset shortcut instruction control used to create a table may be displayed in the interaction component, for example, a shortcut instruction control, “Build a service system” and a shortcut instruction control, “Build a task management table”. For another example, after the target table is created and displayed, the interaction component may display a preset shortcut instruction control related to field modification or the like, such as a shortcut instruction control for deleting an existing field and a shortcut instruction control for adding a new field. For another example, when the user needs to add a row of data to be added to the target table, the interaction component may display a preset shortcut instruction control related to data addition or the like. For another example, in the process of generating the target table, the interaction component may display a preset operation instruction control for the current creation process, including but not limited to a retry control and/or an interruption control. For another example, after the target table is generated, the interaction component may further display a preset operation instruction control for the target table, including but not limited to one or more of an acceptance control, a retry control, and a discard control. It should be noted that different cases in the table interface are not limited to the above examples. In another optional case, the preset shortcut instruction control in the interaction component is not described in this embodiment.

Corresponding to the table creation method in the above embodiment, FIG. 9 is a block diagram of a structure of a table creation device according to an embodiment of the present disclosure. For ease of illustration, only parts related to this embodiment of the present disclosure are shown. With reference to FIG. 9, the table creation device 900 includes: an input unit 901, a processing unit 902, and a display unit 903.

The input unit 901 is configured to receive a first user input instruction through an interaction component in a table interface, where the first user input instruction includes table creation requirement information.

The processing unit 902 is configured to invoke a language model based on the first user input instruction, to create a target table that satisfies the table creation requirement information.

The display unit 903 is configured to present the target table in the table interface.

In one or more embodiments of the present disclosure, when invoking the language model based on the first user input instruction, to create the target table that satisfies the table creation requirement information, the processing unit 902 is configured to:
generate model input data using a preset template based on the first user input instruction;
process the model input data based on the language model, to obtain target table data that satisfies the table creation requirement information; and
parse the target table data, and create the target table in the table interface based on a parsing result.

In one or more embodiments of the present disclosure, the target table data includes one or more of the following:
a number of tables included in the target table and a subject of each table, a field name in the table, an option of at least one field, example data in the table, and real data in the table.

In one or more embodiments of the present disclosure, when receiving the first user input instruction through the interaction component in the table interface, the input unit 901 is configured to:
receive instruction content that is based on natural language and is input into an input box control in the interaction component, and determine the instruction content to be the first user input instruction;
in response to a trigger operation on a preset shortcut instruction control in the interaction component, determine a preset shortcut instruction corresponding to the preset shortcut instruction control to be the first user input instruction;
in response to a trigger operation on a preset shortcut instruction control in the interaction component, display a preset prompt corpus in an input box control in the interaction component, receive instruction content that is based on the natural language and is input by a user into the input box control for the preset prompt corpus, and determine the preset prompt corpus and the instruction content to be the first user input instruction; or
receive the instruction content that is based on the natural language and is input into an input box control in the interaction component, display, in the interaction component, a preset shortcut instruction control that matches the instruction content, and determine, in response to a trigger operation on the preset shortcut instruction control, a preset shortcut instruction corresponding to the preset shortcut instruction control to be the first user input instruction.

In one or more embodiments of the present disclosure, the input unit 901 is further configured to: after the target table is presented in the table interface, receive a second user input instruction through the interaction component, where the second user input instruction includes field modification requirement information for the target table, and the field modification requirement information includes requirement information for modifying an existing field, requirement information for deleting an existing field, or requirement information for adding a new field; and
the processing unit 902 is further configured to invoke the language model based on the second user input instruction, to perform field modification on the target table based on the field modification requirement information.

In one or more embodiments of the present disclosure, the input unit 901 is further configured to: after the target table is presented in the table interface, receive a third user input instruction through the interaction component, where the third user input instruction includes data addition requirement information for the target table, and the data addition requirement information includes data information to be added that is based on natural language; and
the processing unit 902 is further configured to invoke the language model based on the third user input instruction, to add the data information to be added to a row of the target table according to a field.

In one or more embodiments of the present disclosure, when receiving the third user input instruction through the interaction component, the input unit 901 is configured to:
in response to a trigger operation for any cell in any row of the target table, display a thumbnail identifier of the interaction component in the cell; and
in response to a trigger of the thumbnail identifier, display the interaction component, and receive the third user input instruction through the interaction component.

In one or more embodiments of the present disclosure, the input unit 901 is further configured to:
display the interaction component in response to a trigger operation on a thumbnail identifier of the interaction component that is displayed at a preset position in the table interface.

In one or more embodiments of the present disclosure, during the process of invoking a language model based on the first user input instruction, to create a target table that satisfies the table creation requirement information, the input unit 901 is further configured to display creation status prompt information and a preset operation instruction control for the current creation process in the interaction component, where the preset operation instruction control for the creation process includes a retry control and/or an interruption control; and
the processing unit 902 is further configured to: in response to a trigger operation on the retry control, stop the current creation process, revoke the generated target table, and re-invoke the language model based on the first user input instruction, to create a target table that satisfies the table creation requirement information; or
the processing unit 902 is further configured to: in response to a trigger operation on the interruption control, stop the current creation process, and retain or revoke the generated target table.

In one or more embodiments of the present disclosure, after the target table is presented in the table interface, the input unit 901 is further configured to display a preset operation instruction control for the target table in the interaction component, where the preset operation instruction control for the target table includes one or more of an acceptance control, a retry control, and a discard control; and
the processing unit 902 is further configured to: in response to a trigger operation on the acceptance control, complete creation of the target table, and exit the interaction component; or
the processing unit 902 is further configured to: in response to a trigger operation on the retry control, revoke the target table, and re-invoke the language model based on the first user input instruction, to create a target table that satisfies the table creation requirement information; or
in response to a trigger operation on the discard control, revoke the target table.

In one or more embodiments of the present disclosure,
the input unit 901 is further configured to: display first prompt information in response to a trigger operation on another area outside the interaction component, where the first prompt information includes prompt information for accepting or discarding the generated target table or prompt information for interrupting a current creation process.

In one or more embodiments of the present disclosure, the input unit 901 is further configured to: for a user input instruction that is based on natural language and is input into an input box control in the interaction component, when it is determined that the language model fails to perform processing, display second prompt information in the interaction component, where the second prompt information is used to indicate that the user input instruction fails to be processed or is used to prompt a user to input another instruction.

The device provided in this embodiment may be configured to perform the technical solution of the above method embodiment. The implementation principle and technical effects thereof are similar, and are not described herein again in this embodiment.

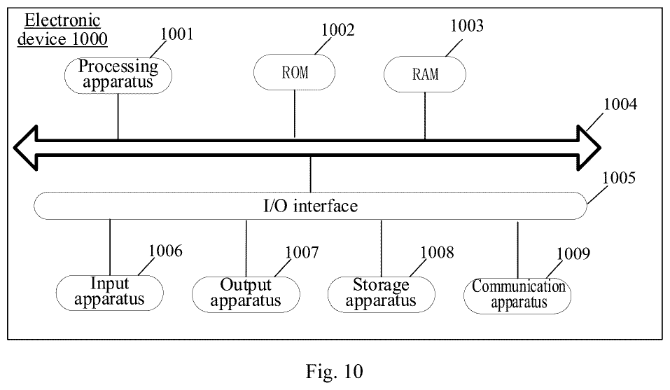

FIG. 10 is a schematic diagram of a structure of an electronic device 1000 suitable for implementing the embodiments of the present disclosure. The electronic device 1000 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 10 is merely an example, and shall not impose any limitation on the function and scope of use of the embodiments of the present disclosure.

As shown in FIG. 10, the electronic device 1000 may include a processing apparatus (e.g., a central processing unit or a graphics processing unit) 1001 that may perform a variety of appropriate actions and processing in accordance with a program stored in a read-only memory (ROM) 1002 or a program loaded from a storage apparatus 1008 into a random access memory (RAM) 1003. The RAM 1003 further stores various programs and data required for the operation of the electronic device 1000. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touchscreen, a touchpad, a keyboard, a mouse, a camera, a microphone, an accelerometer, and a gyroscope; an output apparatus 1007 including, for example, a liquid crystal display (LCD), a speaker, and a vibrator; the storage apparatus 1008 including, for example, a tape and a hard disk; and a communication apparatus 1009. The communication apparatus 1009 may allow the electronic device 1000 to perform wireless or wired communication with other devices to exchange data. Although FIG. 10 shows the electronic device 1000 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 1009 and installed, installed from the storage apparatus 1008, or installed from the ROM 1002. When the computer program is executed by the processing apparatus 1001, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In a first aspect, according to one or more embodiments of the present disclosure, there is provided a table creation method. The method includes:
receiving a first user input instruction through an interaction component in a table interface, where the first user input instruction includes table creation requirement information;
invoking a language model based on the first user input instruction, to create a target table that satisfies the table creation requirement information; and
presenting the target table in the table interface.

According to one or more embodiments of the present disclosure, the invoking a language model based on the first user input instruction, to create a target table that satisfies the table creation requirement information includes:
generating model input data using a preset template based on the first user input instruction;
processing the model input data based on the language model, to obtain target table data that satisfies the table creation requirement information; and
parsing the target table data, and creating the target table in the table interface based on a parsing result.

According to one or more embodiments of the present disclosure, the target table data includes one or more of the following:
the number of tables included in the target table and a subject of each table, a field name in the table, an option of at least one field, example data in the table, and real data in the table.

According to one or more embodiments of the present disclosure, the receiving a first user input instruction through an interaction component in a table interface includes:
receiving instruction content that is based on natural language and is input into an input box control in the interaction component, and determining the instruction content to be the first user input instruction; or
in response to a trigger operation on a preset shortcut instruction control in the interaction component, determining a preset shortcut instruction corresponding to the preset shortcut instruction control to be the first user input instruction; or
in response to a trigger operation on a preset shortcut instruction control in the interaction component, displaying a preset prompt corpus in an input box control in the interaction component, receiving instruction content that is based on natural language and is input by a user into the input box control for the preset prompt corpus, and determining the preset prompt corpus and the instruction content to be the first user input instruction; or
receiving the instruction content that is based on natural language and is input into an input box control in the interaction component, displaying, in the interaction component, a preset shortcut instruction control that matches the instruction content, and determining, in response to a trigger operation on the preset shortcut instruction control, a preset shortcut instruction corresponding to the preset shortcut instruction control to be the first user input instruction.

According to one or more embodiments of the present disclosure, after the presenting the target table in the table interface, the method further includes:
receiving a second user input instruction through the interaction component, where the second user input instruction includes field modification requirement information for the target table, and the field modification requirement information includes requirement information for modifying an existing field, requirement information for deleting an existing field, or requirement information for adding a new field; and
invoking the language model based on the second user input instruction, to perform field modification on the target table based on the field modification requirement information.

According to one or more embodiments of the present disclosure, after the presenting the target table in the table interface, the method further includes:
receiving a third user input instruction through the interaction component, where the third user input instruction includes data addition requirement information for the target table, and the data addition requirement information includes data information to be added that is based on natural language; and
invoking the language model based on the third user input instruction, to add the data information to be added to a row of the target table by field.

According to one or more embodiments of the present disclosure, the receiving a third user input instruction through the interaction component includes:
in response to a trigger operation for any cell in any row of the target table, displaying a thumbnail identifier of the interaction component in the cell; and
in response to a trigger of the thumbnail identifier, displaying the interaction component, and receiving the third user input instruction through the interaction component.

According to one or more embodiments of the present disclosure, the method further includes:
displaying the interaction component in response to a trigger operation on a thumbnail identifier of the interaction component that is displayed at a preset position in the table interface.

According to one or more embodiments of the present disclosure, during the process of invoking a language model based on the first user input instruction, to create a target table that satisfies the table creation requirement information, the method further includes:
displaying creation status prompt information and a preset operation instruction control for the current creation process in the interaction component, where the preset operation instruction control for the creation process includes a retry control and/or an interruption control; and
in response to a trigger operation on the retry control, stopping the current creation process, revoking the generated target table, and re-invoking the language model based on the first user input instruction, to create a target table that satisfies the table creation requirement information; or
in response to a trigger operation on the interruption control, stopping the current creation process, and retaining or revoking the generated target table.

According to one or more embodiments of the present disclosure, after the presenting the target table in the table interface, the method further includes:
displaying a preset operation instruction control for the target table in the interaction component, where the preset operation instruction control for the target table includes one or more of an acceptance control, a retry control, and a discard control; and
in response to a trigger operation on the acceptance control, completing creation of the target table, and exiting the interaction component; or
in response to a trigger operation on the retry control, revoking the target table, and re-invoking the language model based on the first user input instruction, to create a target table that satisfies the table creation requirement information; or
in response to a trigger operation on the discard control, revoking the target table.

According to one or more embodiments of the present disclosure, the method further includes:

displaying first prompt information in response to a trigger operation on another area outside the interaction component, where the first prompt information includes prompt information for accepting or discarding the generated target table or prompt information for interrupting a current creation process.

According to one or more embodiments of the present disclosure, the method further includes:
for a user input instruction that is based on natural language and is input into an input box control in the interaction component, when it is determined that the language model fails to perform processing, displaying second prompt information in the interaction component, where the second prompt information is used to indicate that the user input instruction fails to be processed or is used to prompt a user to input another instruction.

In a second aspect, according to one or more embodiments of the present disclosure, there is provided a table creation device. The device includes an input unit, a processing unit, and a display unit.

The input unit is configured to receive a first user input instruction through an interaction component in a table interface, where the first user input instruction includes table creation requirement information.

The processing unit is configured to invoke a language model based on the first user input instruction, to create a target table that satisfies the table creation requirement information.

The display unit is configured to present the target table in the table interface.

According to one or more embodiments of the present disclosure, when invoking the language model based on the first user input instruction, to create the target table that satisfies the table creation requirement information, the processing unit is configured to:
generate model input data using a preset template based on the first user input instruction;
process the model input data based on the language model, to obtain target table data that satisfies the table creation requirement information; and
parse the target table data, and create the target table in the table interface based on a parsing result.

According to one or more embodiments of the present disclosure, the target table data includes one or more of the following:
the number of tables included in the target table and a subject of each table, a field name in the table, alternatives to at least one field, example data in the table, and real data in the table.

According to one or more embodiments of the present disclosure, when receiving the first user input instruction through the interaction component in the table interface, the input unit is configured to:
receive instruction content that is based on natural language and is input into an input box control in the interaction component, and determine the instruction content to be the first user input instruction; or
in response to a trigger operation on a preset shortcut instruction control in the interaction component, determine a preset shortcut instruction corresponding to the preset shortcut instruction control to be the first user input instruction; or
in response to a trigger operation on a preset shortcut instruction control in the interaction component, display a preset prompt corpus in an input box control in the interaction component, receive instruction content that is based on natural language and is input by a user into the input box control for the preset prompt corpus, and determine the preset prompt corpus and the instruction content to be the first user input instruction; or
receive the instruction content that is based on natural language and is input into an input box control in the interaction component, display, in the interaction component, a preset shortcut instruction control that matches the instruction content, and determine, in response to a trigger operation on the preset shortcut instruction control, a preset shortcut instruction corresponding to the preset shortcut instruction control to be the first user input instruction.

According to one or more embodiments of the present disclosure, the input unit is further configured to: after the target table is presented in the table interface, receive a second user input instruction through the interaction component, where the second user input instruction includes field modification requirement information for the target table, and the field modification requirement information includes requirement information for modifying an existing field, requirement information for deleting an existing field, or requirement information for adding a new field; and
the processing unit is further configured to invoke the language model based on the second user input instruction, to perform field modification on the target table based on the field modification requirement information.

According to one or more embodiments of the present disclosure, the input unit is further configured to: after the target table is presented in the table interface, receive a third user input instruction through the interaction component, where the third user input instruction includes data addition requirement information for the target table, and the data addition requirement information includes data information to be added that is based on natural language; and
the processing unit is further configured to invoke the language model based on the third user input instruction, to add the data information to be added to a row of the target table according to a field.

According to one or more embodiments of the present disclosure, when receiving the third user input instruction through the interaction component, the input unit is configured to:
in response to a trigger operation for any cell in any row of the target table, display a thumbnail identifier of the interaction component in the cell; and
in response to a trigger of the thumbnail identifier, display the interaction component, and receive the third user input instruction through the interaction component.

According to one or more embodiments of the present disclosure, the input unit is further configured to:
display the interaction component in response to a trigger operation on a thumbnail identifier of the interaction component that is displayed at a preset position in the table interface.

According to one or more embodiments of the present disclosure, during the process of invoking a language model based on the first user input instruction, to create a target table that satisfies the table creation requirement information, the input unit is further configured to display creation status prompt information and a preset operation instruction control for the current creation process in the interaction component, where the preset operation instruction control for the creation process includes a retry control and/or an interruption control; and
the processing unit is further configured to: in response to a trigger operation on the retry control, stop the current creation process, revoke the generated target table, and re-invoke the language model based on the first user input instruction, to create a target table that satisfies the table creation requirement information; or
the processing unit is further configured to: in response to a trigger operation on the interruption control, stop the current creation process, and retain or revoke the generated target table.

According to one or more embodiments of the present disclosure, after the target table is presented in the table interface, the input unit is further configured to display a preset operation instruction control for the target table in the interaction component, where the preset operation instruction control for the target table includes one or more of an acceptance control, a retry control, and a discard control; and
the processing unit is further configured to: in response to a trigger operation on the acceptance control, complete creation of the target table, and exit the interaction component; or
the processing unit is further configured to: in response to a trigger operation on the retry control, revoke the target table, and re-invoke the language model based on the first user input instruction, to create a target table that satisfies the table creation requirement information; or
in response to a trigger operation on the discard control, revoke the target table.

According to one or more embodiments of the present disclosure,
the input unit is further configured to: display first prompt information in response to a trigger operation on another area outside the interaction component, where the first prompt information includes prompt information for accepting or discarding the generated target table or prompt information for interrupting a current creation process.

According to one or more embodiments of the present disclosure, the input unit is further configured to: for any user input instruction that is based on natural language and is input into an input box control in the interaction component, if it is determined that the language model fails to perform processing, display second prompt information in the interaction component, where the second prompt information is used to indicate that the user input instruction fails to be processed or is used to prompt a user to input another instruction.

In a third aspect, according to one or more embodiments of the present disclosure, there is provided an electronic device. The electronic device includes: at least one processor and a memory,
where the memory stores computer-executable instructions; and
the at least one processor executes the computer-executable instructions stored in the memory, to cause the at least one processor to perform the table creation method according to the above first aspect and various possible designs of the first aspect.

In a fourth aspect, according to one or more embodiments of the present disclosure, a computer-readable storage medium is provided. The computer-readable storage medium stores computer-executable instructions. When executing the computer-executable instructions, a processor implements the table creation method according to the above first aspect and various possible designs of the first aspect.

According to a fifth aspect, according to one or more embodiments of the present disclosure, there is provided a computer program product, including computer-executable instructions. When executing the computer-executable instructions, a processor implements the table creation method according to the above first aspect and various possible designs of the first aspect.

The above descriptions are merely preferred embodiments of the present disclosure and explanations of the applied technical principles. Those skilled in the art should understand that the scope of disclosure involved in the present disclosure is not limited to the technical solutions formed by specific combinations of the above technical features, and shall also cover other technical solutions formed by any combination of the above technical features or equivalent features thereof without departing from the above concept of disclosure. For example, a technical solution formed by a replacement of the above features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the above discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A table creation method, comprising:
receiving a first user input instruction through an interaction component in a table interface, wherein the first user input instruction comprises table creation requirement information;
invoking a language model based on the first user input instruction, to create a target table that satisfies the table creation requirement information; and
presenting the target table in the table interface.

2. The method according to claim 1, wherein the invoking a language model based on the first user input instruction, to create a target table that satisfies the table creation requirement information comprises:
generating model input data using a preset template, based on the first user input instruction;
processing the model input data based on the language model, to obtain target table data that satisfies the table creation requirement information; and
parsing the target table data, and creating the target table in the table interface based on a parsing result.

3. The method according to claim 2, wherein the target table data comprises one or more of the following:
a number of tables comprised in the target table and a subject of each table, a field name in the table, an option of at least one field, example data in the table, and real data in the table.

4. The method according to claim 1, wherein the receiving a first user input instruction through an interaction component in a table interface comprises:
receiving instruction content that is based on natural language and is input into an input box control in the interaction component, and determining the instruction content to be the first user input instruction;
in response to a trigger operation on a preset shortcut instruction control in the interaction component, determining a preset shortcut instruction corresponding to the preset shortcut instruction control to be the first user input instruction;
in response to the trigger operation on the preset shortcut instruction control in the interaction component, displaying a preset prompt corpus in the input box control in the interaction component, receiving instruction content that is based on the natural language and is input by a user into the input box control for the preset prompt corpus, and determining the preset prompt corpus and the instruction content to be the first user input instruction; or
receiving the instruction content that is based on the natural language and input into the input box control in the interaction component, displaying, in the interaction component, a preset shortcut instruction control that matches the instruction content, and determining, in response to the trigger operation on the preset shortcut instruction control, the preset shortcut instruction corresponding to the preset shortcut instruction control to be the first user input instruction.

5. The method according to claim 1, wherein after the presenting the target table in the table interface, the method further comprises:
receiving a second user input instruction through the interaction component, wherein the second user input instruction comprises field modification requirement information for the target table, and the field modification requirement information comprises requirement information for modifying an existing field, requirement information for deleting an existing field, or requirement information for adding a new field; and
invoking the language model based on the second user input instruction, to perform field modification on the target table based on the field modification requirement information.

6. The method according to claim 1, wherein after the presenting the target table in the table interface, the method further comprises:
receiving a third user input instruction through the interaction component, wherein the third user input instruction comprises data addition requirement information for the target table, and the data addition requirement information comprises data information to be added that is based on natural language; and
invoking the language model based on the third user input instruction, to add the data information to be added to a row of the target table according to a field.

7. The method according to claim 6, wherein the receiving a third user input instruction through the interaction component comprises:
in response to a trigger operation for a cell in a row of the target table, displaying a thumbnail identifier of the interaction component in the cell; and
in response to a trigger of the thumbnail identifier, displaying the interaction component, and receiving the third user input instruction through the interaction component.

8. The method according to claim 1, wherein the method further comprises:
displaying the interaction component in response to a trigger operation on a thumbnail identifier of the interaction component that is displayed at a preset position in the table interface.

9. The method according to claim 1, wherein during a process of invoking a language model based on the first user input instruction, to create a target table that satisfies the table creation requirement information, the method further comprises:
displaying creation status prompt information and a preset operation instruction control for a current creation process in the interaction component, wherein the preset operation instruction control for the creation process comprises a retry control and/or an interruption control; and
in response to a trigger operation on the retry control, stopping the current creation process, revoking the generated target table, and re-invoking the language model based on the first user input instruction, to create the target table that satisfies the table creation requirement information; or
in response to a trigger operation on the interruption control, stopping the current creation process, and retaining or revoking the generated target table.

10. The method according to claim 1, wherein after the presenting the target table in the table interface, the method further comprises:
displaying a preset operation instruction control for the target table in the interaction component, wherein the preset operation instruction control for the target table comprises one or more of an acceptance control, a retry control, and a discard control; and
in response to a trigger operation on the acceptance control, completing creation of the target table, and exiting the interaction component;
in response to a trigger operation on the retry control, revoking the target table, and re-invoking the language model based on the first user input instruction, to create the target table that satisfies the table creation requirement information; or
in response to a trigger operation on the discard control, revoking the target table.

11. The method according to claim 1, wherein the method further comprises:
displaying first prompt information in response to a trigger operation on another area outside the interaction component, wherein the first prompt information comprises prompt information for accepting or discarding the generated target table or prompt information for interrupting a current creation process.

12. The method according to claim 1, wherein the method further comprises:
for a user input instruction that is based on natural language and is input into an input box control in the interaction component, when it is determined that the language model fails to perform processing, displaying second prompt information in the interaction component, wherein the second prompt information is used to indicate that the user input instruction fails to be processed or is used to prompt a user to input another instruction.

13. An electronic device, comprising: at least one processor and a memory,
wherein the memory stores computer-executable instructions; and
the at least one processor executes the computer-executable instructions stored in the memory, to cause the at least one processor to perform a table creation method, and the table creation method comprises:
receiving a first user input instruction through an interaction component in a table interface, wherein the first user input instruction comprises table creation requirement information;
invoking a language model based on the first user input instruction, to create a target table that satisfies the table creation requirement information; and
presenting the target table in the table interface.

14. The electronic device according to claim 13, wherein the invoking a language model based on the first user input instruction, to create a target table that satisfies the table creation requirement information comprises:
generating model input data using a preset template, based on the first user input instruction;
processing the model input data based on the language model, to obtain target table data that satisfies the table creation requirement information; and
parsing the target table data, and creating the target table in the table interface based on a parsing result.

15. The electronic device according to claim 14, wherein the target table data comprises one or more of the following:
a number of tables comprised in the target table and a subject of each table, a field name in the table, an option of at least one field, example data in the table, and real data in the table.

16. The electronic device according to claim 13, wherein the receiving a first user input instruction through an interaction component in a table interface comprises:
receiving instruction content that is based on natural language and is input into an input box control in the interaction component, and determining the instruction content to be the first user input instruction;
in response to a trigger operation on a preset shortcut instruction control in the interaction component, determining a preset shortcut instruction corresponding to the preset shortcut instruction control to be the first user input instruction;
in response to the trigger operation on the preset shortcut instruction control in the interaction component, displaying a preset prompt corpus in the input box control in the interaction component, receiving instruction content that is based on the natural language and is input by a user into the input box control for the preset prompt corpus, and determining the preset prompt corpus and the instruction content to be the first user input instruction; or
receiving the instruction content that is based on the natural language and input into the input box control in the interaction component, displaying, in the interaction component, a preset shortcut instruction control that matches the instruction content, and determining, in response to the trigger operation on the preset shortcut instruction control, the preset shortcut instruction corresponding to the preset shortcut instruction control to be the first user input instruction.

17. The electronic device according to claim 13, wherein after the presenting the target table in the table interface, the table creation method further comprises:
receiving a second user input instruction through the interaction component, wherein the second user input instruction comprises field modification requirement information for the target table, and the field modification requirement information comprises requirement information for modifying an existing field, requirement information for deleting an existing field, or requirement information for adding a new field; and
invoking the language model based on the second user input instruction, to perform field modification on the target table based on the field modification requirement information.

18. The electronic device according to claim 13, wherein after the presenting the target table in the table interface, the table creation method further comprises:
receiving a third user input instruction through the interaction component, wherein the third user input instruction comprises data addition requirement information for the target table, and the data addition requirement information comprises data information to be added that is based on natural language; and
invoking the language model based on the third user input instruction, to add the data information to be added to a row of the target table according to a field.

19. A non-transitory computer-readable storage medium, storing computer-executable instructions that, when executed by a processor, cause the processor to implement a table creation method, and the table creation method comprises:
receiving a first user input instruction through an interaction component in a table interface, wherein the first user input instruction comprises table creation requirement information;
invoking a language model based on the first user input instruction, to create a target table that satisfies the table creation requirement information; and
presenting the target table in the table interface.

20. The non-transitory computer-readable storage medium according to claim 19, wherein the invoking a language model based on the first user input instruction, to create a target table that satisfies the table creation requirement information comprises:
generating model input data using a preset template, based on the first user input instruction;
processing the model input data based on the language model, to obtain target table data that satisfies the table creation requirement information; and
parsing the target table data, and creating the target table in the table interface based on a parsing result.
